(19) United States
(12) Patent Application Publication
(10) Pub. No.: US 2002/0065706 A1
(43) Pub. Date: May 30, 2002

(54) Method for calculating internet user rating

(75) Inventor: Tatsuya Ishikawa, Toda-shi (JP)

Correspondence Address: REED SMITH HAZEL & THOMAS LLP, Suite 1400, 3110 Fairview Park Drive, Falls Church, VA, 22042, US

(73) Assignee: exNetcom Co., Ltd.

(21) Appl. No.: 09/726,125

(22) Filed: Nov. 30, 2000

(51) Int. Cl. G06F 17/60

(52) U.S. Cl. 705/10

(57) ABSTRACT

The present invention relates to an improvement of a method for calculating the Internet user rating. According to the configuration provided by the invention, the reliability of the analysis is remarkably improved by gaining information with respect to the tastes of users or the change of the tastes of users through the knowledge of access frequency and access contents for a specific period of time before and after the installment of the software application used for the analysis.

### BACKGROUND OF THE INVENTION

This invention relates to an improvement of a method for calculating the Internet user rating.

It is important information for content providers to know, from the point of view that tastes of users can be gained in a timely fashion, what type of users, with respect to age or sex among the general public, have accessed what fields of information.

The types of information desired to be known are too numerous to enumerate, including shifts from one home page to another and how the tastes of the users change, which affects this user rating.

The conventional method to gain this type of information is to collect questionnaires with respect to what types of home pages have been accessed in the past specific period from numerous users so as to add up and analyze the result that is provided to the clients who need this type of information.

However, there is a problem, in the case that the users are asked to respond to those questionnaires, that some users leave blank those questions they hesitate to answer on the form or give wrong answers on purpose and, therefore, as a result the clients cannot gain the intended information accurately.

Recently, a method has been proposed in that monitors are selected randomly from Internet users and a software program called “trap soft” which gains and adds up data is given for a specific period of time to those monitors so as to read out data stored in the so-called “history” data in each of their personal computers. Even in this case, however, the users think about the fact that the “trap soft” is installed and, therefore, accurate, that is to say, natural, access frequency or the access contents by the users cannot be grasped.

### SUMMARY OF THE INVENTION

The purpose of the present invention is, therefore, to be able to provide information which matches the needs of the clients by finding out more accurate Internet user ratings so as to be analyzed if necessary in order to solve the above described problem.

Concretely speaking, the purpose of the present invention is to provide assistance for the development of merchandise with a high success probability or the improvement of merchandise which matches the needs of consumers (users) by grasping the changes in the tastes of the consumers (users) from the above described results as accurately and as soon as possible.

The purpose of the present invention is to grasp the movement of merchandise by rival companies or the movement of newly participating companies accurate access analysis of the customers according to a method of the present invention.

The purpose of the present invention is to provide assistance to develop merchandise in fields that nobody has yet entered judging from the access analysis of the customers according to a method of the present invention.

The purpose of the present invention is to find an appropriate partner for co-development or the like judging from the access analysis of the customers according to a method of the present invention.

Basically, the means for solving the problem is to count the accessed sites and the access frequency in the Internet and it becomes necessary to ask the users to install the application for that in many cases. According to the present invention, however, the accessed sites and the access frequency can be counted, further, by reviewing previously accessed sites from the day of this installment and, as a result, the access information of the users can be grasped accurately.

The characteristic of the present invention is to dramatically enhance the accuracy of the information gained through the operation of the counted number of sites and counted frequency after the installment, in addition to the counted number of sites and the counted amount before the installments.

An additional characteristic of the present invention is to group data of the counted number of sites and the counted frequency before and after the installment according to their purpose of usage for each field so that the information amounts or access contents can be compared or mean values can be, respectively, carried out.

### BRIEF DESCRIPTION OF THE DRAWINGS

FIG. 1 is an illustration for describing a method for calculating the Internet user rating according to the present invention; and

FIG. 2 is a block diagram showing a process over time.

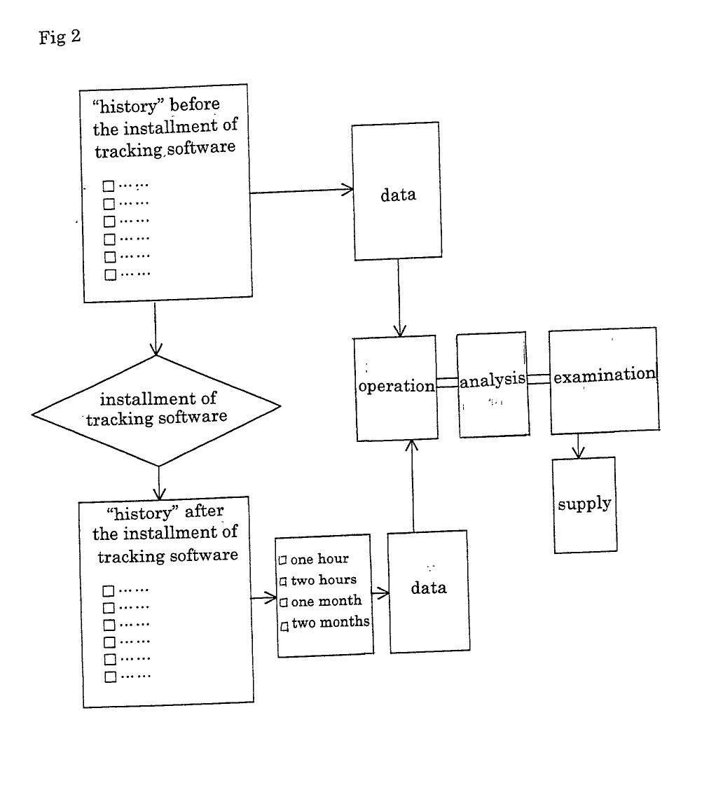

### EXPLANATION OF NUMERALS

1, user

2, intermediary

3, client

### DESCRIPTION OF THE EMBODIMENTS

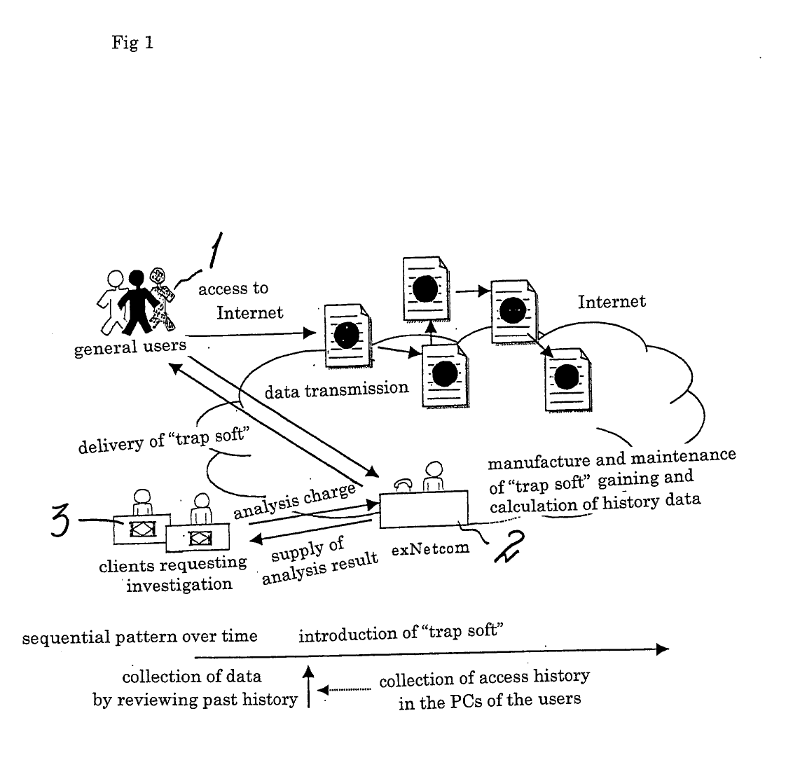

In FIG. 1 a general user of the Internet is denoted as (1), who is selected at random among the Internet users or may be selected from a specific age group or sex.

An intermediary, to whom the client (3) requested this user rating investigation, is denoted as (2), who develop, in many cases alone, software applications, for example, the above described “trap soft.” That is to say, this software is employed to gain or analyze so-called “history” data on a personal computer.

Therefore, this intermediary (2) is usually given a concrete theme by the client (3) such as “we would like to sell merchandise for young people through the Internet and want to know what should be sold.” Then, the intermediary (2) visits the selected Internet user (1) to have the “trap soft,” developed by himself, installed in the user's (1) personal computer. In this case, however, he not only installs this application but clicks a so-called “history” of the user (1). As a result of this the window of this history is opened so that the user's (1) past history of today, yesterday, one week ago or one month ago are displayed and most of the data are secured, recorded and maintained over several weeks or for one month for the time being.

That is to say, the past Internet access record of the user (1) who has this “history” can be gained as information of the access frequency and of the access contents without distortion or awareness of the installment of “trap soft,” which is different from the information gained from the present point onward where “trap soft” is installed.

Next, he visits this user (1) again after a specific period of time, for example several weeks or one month, in order to retrieve the “trap soft” which records the information newly accessed over the Internet by the user (1).

Accordingly, in the case that this retrieved information is analyzed it becomes possible to supply the information which matches the. request of the client (3) who wants this analyzed information. That is to say, in the case that “information truly aimed at” by the Internet user (1) is desired to be known, “history” before installing the above described “trap soft” in the personal computer and “history” after the installment can be compared to take out the access contents so that the true aim of the user (1) can be understood.

As a concrete example, the present inventors gained information from a large sample of women in their 20's and 30's with respect to the theme from the client (1) of “tastes of the users (1) with respect to jewelry,” which was analyzed and it was found that the access number, or the purchases, through the Internet were concentrated on the information concerning cross-type diamond rings of approximately 0.3 carats, which are relatively cheap, before the installment of the “trap soft” and, in contrast, they were concentrated on the information concerning straight line diamond rings of approximately 1 to 2 carats, which are expensive, after the installment.

Obviously, this results from the awareness that the above described “trap soft” is installed and, thereby, important information can be gained in that, in reality, even though women in their 20's and 30's want diamonds of approximately 2 to 3 carats they purchase cross-type diamond rings of 0.2 to 0.3 carats.

In the same way, it properly reveals the information required to be known by the management, such as what kind of accessories are in fashion among young people at present, in other words, what types of accessories should by manufactured, the movement of rival companies in the same industry and the movement of companies newly participating in the market, as well as how much the users are interested in those companies.

Generally speaking, the effects of the present invention are to remarkably improve the reliability of the analysis by gaining information with respect to the tastes of users or the change of the tastes of users through the knowledge of access frequency and access contents for a specific period of time before and after the installment of the software application used for the analysis.

What is claimed is:

1. A method for calculating Internet user rating characterized in that, when the number of sites accessed and access frequency on the Internet are counted, user access can be grasped accurately by counting the number of sites accessed and the access frequency by reviewing past activity from the day the application is installed.

2. A method for calculating Internet user rating characterized in that, when the number of sites accessed and access frequency on the Internet are counted, the accesses of the users can be grasped accurately by counting the number of sites accessed and the access frequency by reviewing the past from the day the application is installed and by going through the comparison operation of the number of sites accessed and access frequency before said installment and the number of sites accessed and access frequency after said installment.

3. A method for calculating Internet user rating characterized in that, when the number of sites accessed and access frequency on the Internet are counted, the accesses of the users can be grasped accurately by counting the number of sites accessed and the access frequency by reviewing the past from the day the application is installed and by using the data from the comparison operation of the number of sites accessed and access frequency before said installment and the number of sites accessed and access frequency after said installment so that the fields of information are grouped to be compared in the information amount or the content or to calculate out mean values in the respective grouped fields.
